(19) United States
(12) Patent Application Publication
(10) Pub. No.: US 2012/0314631 A1
(43) Pub. Date: Dec. 13, 2012

(54) METHOD FOR TRANSMITTING/RECEIVING DATA OF APPLICATION FOR ONE COMMUNICATION PROTOCOL BY ANOTHER COMMUNICATION PROTOCOL, AND RELATED NON-TRANSITORY MACHINE READABLE MEDIUM THEREOF

(76) Inventors: Lin-Hao Yang, New Taipei City (TW); Chung-Shine Huang, Hsinchu County (TW)

(21) Appl. No.: 13/491,592

(22) Filed: Jun. 7, 2012

Related U.S. Application Data
(60) Provisional application No. 61/495,387, filed on Jun. 10, 2011.

(30) Foreign Application Priority Data
Apr. 13, 2012 (CN) 201210109356.X

(51) Int. Cl. H04L 29/06; H04W 80/00

(52) U.S. Cl. 370/310; 370/466

(57) ABSTRACT

A data transmission method includes: receiving a first data of an application dedicated to a first communication protocol; converting the first data into a second data corresponding to a second communication protocol different from the first communication protocol; and directing the second data to a communication device which is configured to transmit the second data via the second communication protocol, wherein the first communication protocol does not control transmission of the second data. A data reception method includes: obtaining a first data from a communication device which is configured to receive the first data via a first communication protocol different from a second communication protocol, wherein the second communication protocol does not control reception of the first data; converting the first data into a second data corresponding to the second communication protocol; and transmitting the second data to an application dedicated to the second communication protocol.

### CROSS REFERENCE TO RELATED APPLICATIONS

This application claims the benefit of U.S. provisional application No. 61/495,387, filed on Jun. 10, 2011 and incorporated herein by reference.

### BACKGROUND

The disclosed embodiments of the present invention relate to data transaction between different apparatuses, and more particularly, to a method for transmitting/receiving data of an application for one communication protocol by another communication protocol, and related non-transitory machine readable medium thereof.

With the advance of the wireless communication technology, one apparatus is capable of performing data transmission communication with other apparatuses through wireless communication protocols, such as Bluetooth, wireless fidelity (Wi-Fi), etc. Since Bluetooth technology was very early developed, there are many Bluetooth applications. For example, a pear-to-pear communication application is commonly supported by a variety of Bluetooth devices, such as mobile phones. As to Wi-Fi technology, since it is proposed later than Bluetooth, fewer applications are available. For example, Wi-Fi ad-hoc mode is the commonly used application. Due to development of Wi-Fi Direct standard, Wi-Fi devices are allowed to communicate with each other without the need for wireless access points. That is, the operation of Wi-Fi Direct application is similar to that of Bluetooth application. For example, Wi-Fi Direct application can support document/file sharing, printing and synchronization between two Wi-Fi devices. However, since Wi-Fi Direct standard is announced recently, there are no many Wi-Fi Direct applications available to users.

Further, since different protocols may have different advantages for different applications, one may want to utilize multiple protocols to get the best performance for their applications.

Thus, there is a desire for an innovative design which can support an application dedicated to one communication protocol (e.g., Bluetooth protocol) through the use of another communication protocol (e.g., Wi-Fi Direct protocol).

### SUMMARY

In accordance with exemplary embodiments of the present invention, a method for transmitting/receiving data of an application for one communication protocol by another communication protocol and related non-transitory machine readable medium thereof are proposed, to solve the above-mentioned problems.

According to a first aspect of the present invention, an exemplary data transmission method is disclosed. The exemplary data transmission method includes: receiving a first data of an application dedicated to a first communication protocol; converting the first data into a second data corresponding to a second communication protocol different from the first communication protocol; and directing the second data to a communication device which is configured to transmit the second data via the second communication protocol, wherein the first communication protocol does not control transmission of the second data.

According to a second aspect of the present invention, an exemplary data reception method is disclosed. The exemplary data reception method includes: obtaining a first data from a communication device via a first communication protocol different from a second communication protocol, wherein the second communication protocol does not control reception of the first data; converting the first data into a second data corresponding to the second communication protocol; and transmitting the second data to an application dedicated to the second communication protocol.

According to a third aspect of the present invention, an exemplary non-transitory machine readable medium having a program code stored therein is disclosed. When executed by a processor, the program code causes the processor to execute following steps: receiving a first data of an application dedicated to a first communication protocol; converting the first data into a second data corresponding to a second communication protocol different from the first communication protocol; and directing the second data to a communication device which is configured to transmit the second data via the second communication protocol, wherein the first communication protocol does not control transmission of the second data.

According to a fourth aspect of the present invention, an exemplary non-transitory machine readable medium having a program code stored therein is disclosed. When executed by a processor, the program code causes the processor to execute following steps: obtaining a first data from a communication device which is configured to receive the first data via a first communication protocol different from a second communication protocol, wherein the second communication protocol does not control reception of the first data; converting the first data into a second data corresponding to the second communication protocol; and delivering the second data to an application dedicated to the second communication protocol.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a communication system according to an exemplary embodiment of the present invention.

FIG. 2 is a flowchart illustrating a data transmission method according to an exemplary embodiment of the present invention.

FIG. 3 is a flowchart illustrating a data reception method according to an exemplary embodiment of the present invention.

FIG. 4 is a diagram illustrating an exemplary implementation of a modified Bluetooth stack architecture having Wi-Fi/Wi-Fi Direct serving as a transport layer.

FIG. 5 is a diagram illustrating an exemplary implementation of a Bluetooth application based on the Wi-Fi/Wi-Fi Direct protocol according to the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

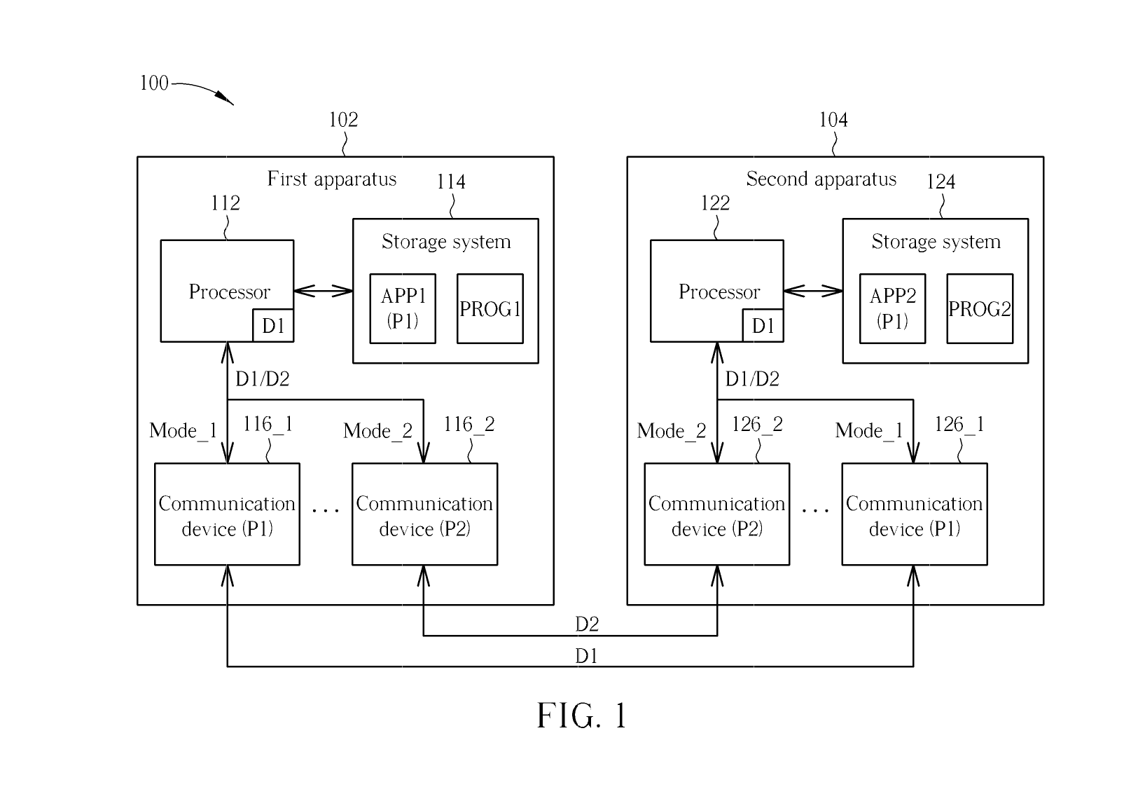

FIG. 1 is a block diagram illustrating a communication system according to an exemplary embodiment of the present invention. The communication system 100 includes a first apparatus 102 and a second apparatus 104, one as a transmitting end and the other one as a receiving end for receiving control information and data generated from the transmitting end. Regarding the first apparatus 102, it includes, but is not limited to, a processor 112, a machine readable medium (e.g., a storage system 114 which may be implemented using one or more memory devices) coupled to the processor 112, and a plurality of communication devices 116_1, 116_2 coupled to the processor 112. Regarding the second apparatus 104, it includes, but is not limited to, a processor 122, a machine readable medium (e.g., a storage system 124 which may be implemented using one or more memory devices) coupled to the processor 122, and a plurality of communication devices 126_1, 126_2 coupled to the processor 122. For clarity and simplicity, only two communication devices disposed in each of the first apparatus 102 and the second apparatus 104 are shown. However, this is not meant to be a limitation of the present invention.

As shown in FIG. 1, each of the storage systems 114 and 124 has application software APP1/APP2 and program code PROG1/PROG2 stored therein. When the application software APP1/APP2 is executed by the processor 112/122, an application dedicated to a communication protocol P1 is enabled. Please note that the communication devices 116_1 and 126_1 are configured to transmit/receive data via the communication protocol P1, whereas the communication devices 116_2 and 126_2 are configured to transmit/receive data via a communication protocol P2 that is different from the communication protocol P1.

When the program code PROG1/PROG2 is executed by the processor 112/122, the program code PROG1/PROG2 is operative to control the transmission and reception of data of an application enabled due to the application software APP1/APP2 also executed by the processor 112/122. Specifically, when a first data transaction mode (i.e., a conventional mode) Mode_1 is selected, the transmission and reception of data of the application dedicated to the communication protocol P1 is performed by means of the communication device 116_1/126_1. However, when a second data transaction mode (i.e., a new mode proposed by the present invention) Mode_2 is selected, the transmission and reception of data of the application dedicated to the communication protocol P1 is performed by means of the communication device 116_2/126_2.

Supposing that the first apparatus 102 acts as a transmitting end and the second apparatus 104 acts as a receiving end, the program code PROG1 executed by the processor 112 therefore employs a data transmission method proposed by the present invention for controlling transmission of data generated from the application software APP1 executed by the same processor 112, and the program code PROG2 executed by the processor 122 therefore employs a data reception method proposed by the present invention for controlling reception of data to be provided to the application software APP2 executed by the same processor 122. Further details are described as below.

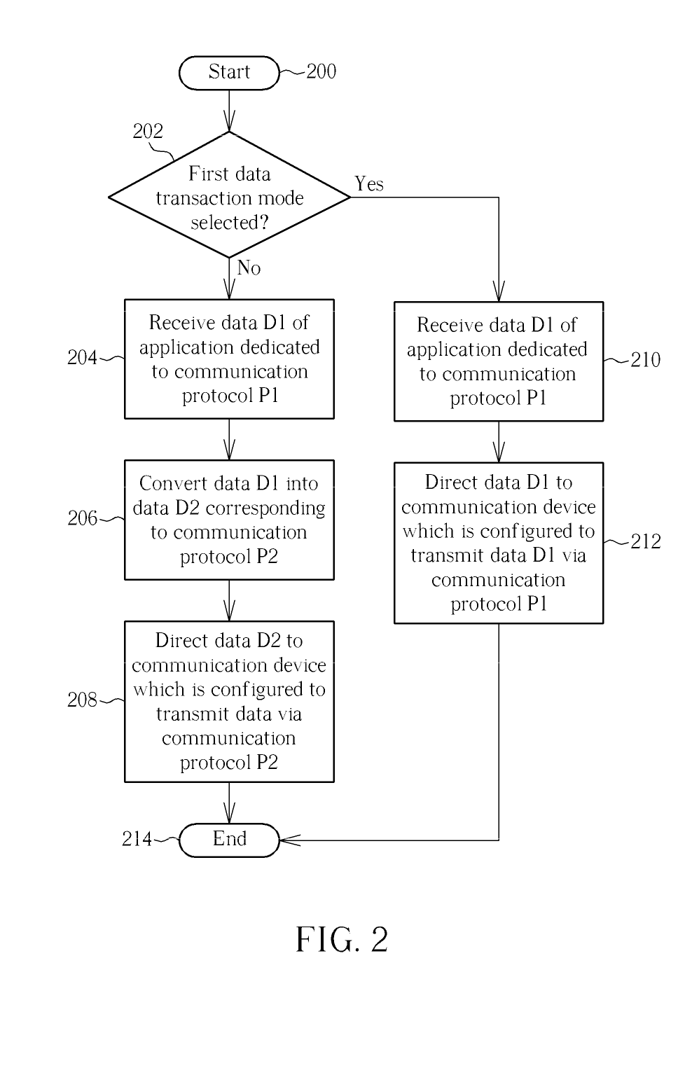

Please refer to FIG. 2 in conjunction with FIG. 1. FIG. 2 is a flowchart illustrating a data transmission method according to an exemplary embodiment of the present invention. The exemplary data transmission method realized by the processor 112 executing the program code PROG1 may be briefly summarized as follows.

Step 200: Start.

Step 202: Check if the first data transaction mode (i.e., a conventional mode) Mode_1 is selected. If yes, go to step 210; otherwise, go to step 204.

Step 204: Receive data D1 of the application dedicated to the communication protocol P1, wherein the application is enabled due to the processor 112 executing the application software APP1.

Step 206: Convert the data D1 corresponding to the communication protocol P1 into data D2 corresponding to the communication protocol P2.

Step 208: Direct the data D2 to the communication device 116_2 which is configured to transmit the data D2 via the communication protocol P2. Go to step 214.

Step 210: Receive the data D1 of the application dedicated to the communication protocol P1, wherein the application is enabled due to the processor 122 executing the application software APP2.

Step 212: Direct the data D1 to the communication device 116_1 which is configured to transmit the data D1 via the communication protocol P1.

Step 214: End.

In step 202, the program code PROG1 executed by the processor 112 checks which data transaction mode is currently selected. For example, the data transaction mode may be manually set by the user. When the first data transaction mode Mode_1 is selected (i.e., the second data transaction mode Mode_2 is not selected), this implies that the data D1 generated from the application dedicated to the communication protocol P1 should be transmitted from the transmitting end (i.e., the first apparatus 102) to the receiving end (i.e., the second apparatus 104) via the communication protocol P1. Hence, the data D1 is directed to the communication device 116_1 for transmission (steps 210 and 212). After receiving the data D1, the communication device 116_1 transmits the received data D1 to the communication device 126_1 disposed at the receiving end.

When the second data transaction mode Mode_2 is selected (i.e., the first data transaction mode Mode_1 is not selected), this implies that the data D1 generated from the application dedicated to the communication protocol P1 should be transmitted from the transmitting end (i.e., the first apparatus 102) to the receiving end (i.e., the second apparatus 104) via the communication protocol P2. Due to the discrepancy between the communication protocols P1 and P2, the data D1 corresponding to the communication protocol P1 is converted into data D2 corresponding to the communication protocol P2 (step 204 and 206). Next, the data D2 is directed to the communication device 116_2 for transmission (step 208). Please note that the communication devices 116_2 and 126_2 may register the specific service of transacting the data D2 derived from the data D1 during a hand-shaking procedure used to establish a link therebetween. After receiving the data D2, the communication device 116_2 transmits the received data D2 to the communication device 126_2 disposed at the receiving end.

In this exemplary embodiment, besides sending the data D2 to the communication device 126_2, the communication device 116_2 is responsible for controlling the transmission of the data D2 between the transmitting end and the receiving end (e.g., establishing a needed link between the first apparatus 102 and the second apparatus 104). To put it another way, the communication protocol P1 does not control transmission of the data D2. Therefore, the communication device 116_1 may be disabled or powered off during the transmission of the data D2. That is, the communication device 116_1 is allowed to be disabled or powered off when the second data transaction mode Mode_2 is selected.

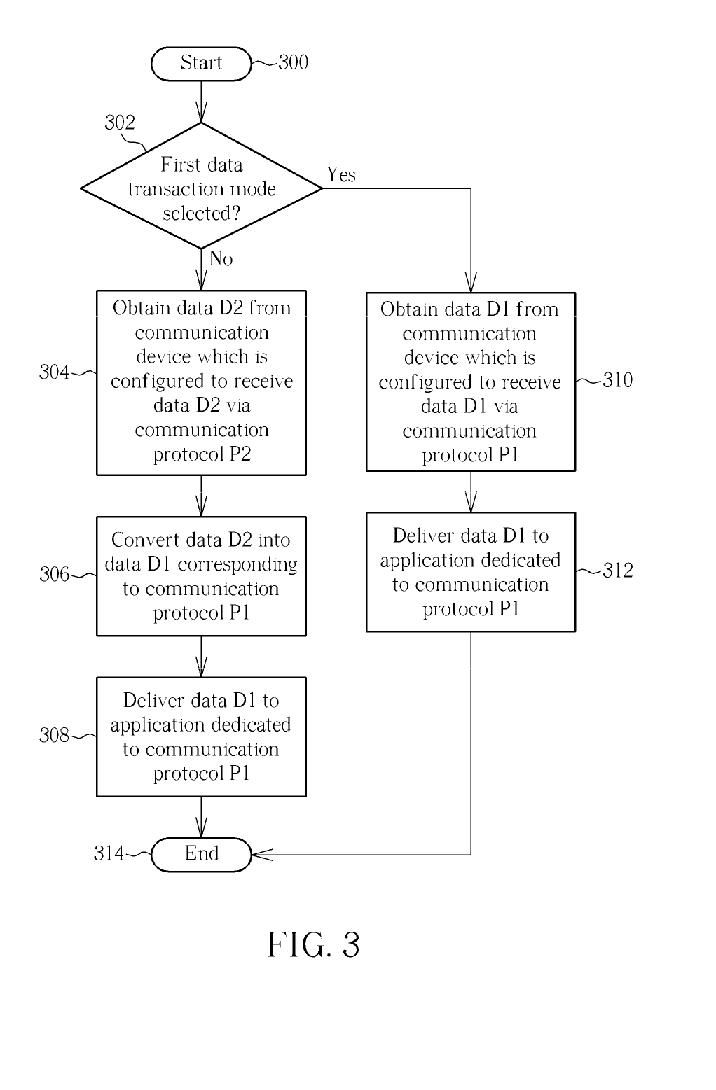

Please refer to FIG. 3 in conjunction with FIG. 1. FIG. 3 is a flowchart illustrating a data reception method according to an exemplary embodiment of the present invention. The exemplary data reception method realized by the processor 122 executing the program code PROG2 may be briefly summarized as follows.

Step 300: Start.

Step 302: Check if the first data transaction mode (i.e., a conventional mode) Mode_1 is selected. If yes, go to step 310; otherwise, go to step 304.

Step 304: Obtain data D2 from the communication device 126_2 which is configured to receive the data D2 via the communication protocol P2.

Step 306: Convert the data D2 corresponding to the communication protocol P2 into data D1 corresponding to the communication protocol P1.

Step 308: Deliver the data D1 to the application dedicated to the communication protocol P1, wherein the application is enabled due to the processor 122 executing the application software APP2. Go to step 314.

Step 310: Obtain data D1 from the communication device 126_1 which is configured to receive the data D1 via the communication protocol P1.

Step 312: Deliver the data D1 to the application dedicated to the communication protocol P1, wherein the application is enabled due to the processor 122 executing the application software APP2.

Step 314: End.

In step 302, the program code PROG2 executed by the processor 122 checks which data transaction mode is currently selected. For example, the data transaction mode may be manually set by the user. When the first data transaction mode Mode_1 is selected (i.e., the second data transaction mode Mode_2 is not selected), this implies that the data to be provided to receiving end's application dedicated to the communication protocol P1 should be received from the transmitting end (i.e., the first apparatus 102) through the communication protocol P1. Hence, the data D1 obtained from the communication device 126_1 is delivered to the application dedicated to the communication protocol P1 (steps 310 and 312).

When the second data transaction mode Mode_2 is selected (i.e., the first data transaction mode Mode_1 is not selected), this implies that the data to be provided to receiving end's application dedicated to the communication protocol P1 should be received from the transmitting end (i.e., the first apparatus 102) through the communication protocol P2. Please note that the communication devices 116_2 and 126_2 may register the specific service of transacting the data D2 derived from the data D1 during a hand-shaking procedure used to establish a link therebetween. Thus, when receiving the data D2, the receiving end (i.e., the second apparatus 104) easily knows that the data D2 transmitted via the communication protocol P2 is for the application dedicated to the communication protocol P1. Due to the discrepancy between the communication protocols P1 and P2, the data D2 obtained from the communication device 126_2 is converted into data D1 corresponding to the communication protocol P1 (step 304 and 306). Next, the data D1 is delivered to the application dedicated to the communication protocol P1 (step 308). In this exemplary embodiment, besides receiving the data D2, the communication device 126_2 is responsible for controlling the reception of the data D2 between the transmitting end and the receiving end (e.g., establishing a needed link between the first apparatus 102 and the second apparatus 104). To put it another way, the communication protocol P1 does not control reception of the data D2. Therefore, the communication device 126_1 may be disabled or powered off during the reception of the data D2. That is, the communication device 126_1 is allowed to be disabled or powered off when the second data transaction mode Mode_2 is selected.

Each of the aforementioned communication protocols P1 and P2 may be any wired or wireless communication protocol. In one exemplary design, the communication protocol P1 may be a wireless communication protocol such as Bluetooth protocol, and the other communication protocol P2 may be Wi-Fi protocol or Wi-Fi Direct protocol. In another exemplary design, the communication protocol P1 may be Bluetooth protocol, and the other communication protocol P2 may be a universal serial bus (USB) protocol or a serial-port protocol. As mentioned above, various applications dedicated to Bluetooth protocol have been proposed due to the fact that Bluetooth technology has been developed for a long time. Thus, with the proposed data transmission method employed by the transmitting end and the proposed reception method employed by the receiving end, the use of Bluetooth applications may be easily extended to other communication protocols having rarely supported applications. Moreover, in a case where the communication protocol P2 is a wireless communication protocol (e.g., Wi-Fi/Wi-Fi Direct protocol) that supports a maximum wireless transmission distance longer than a maximum wireless transmission distance supported by Bluetooth protocol, the service range of the Bluetooth applications is increased accordingly. Moreover, in another case where the communication protocol P2 (e.g., Wi-Fi/Wi-Fi Direct protocol) supports a maximum data transfer rate higher than a maximum data transfer rate supported by the Bluetooth protocol, the throughput of the Bluetooth application is increased accordingly.

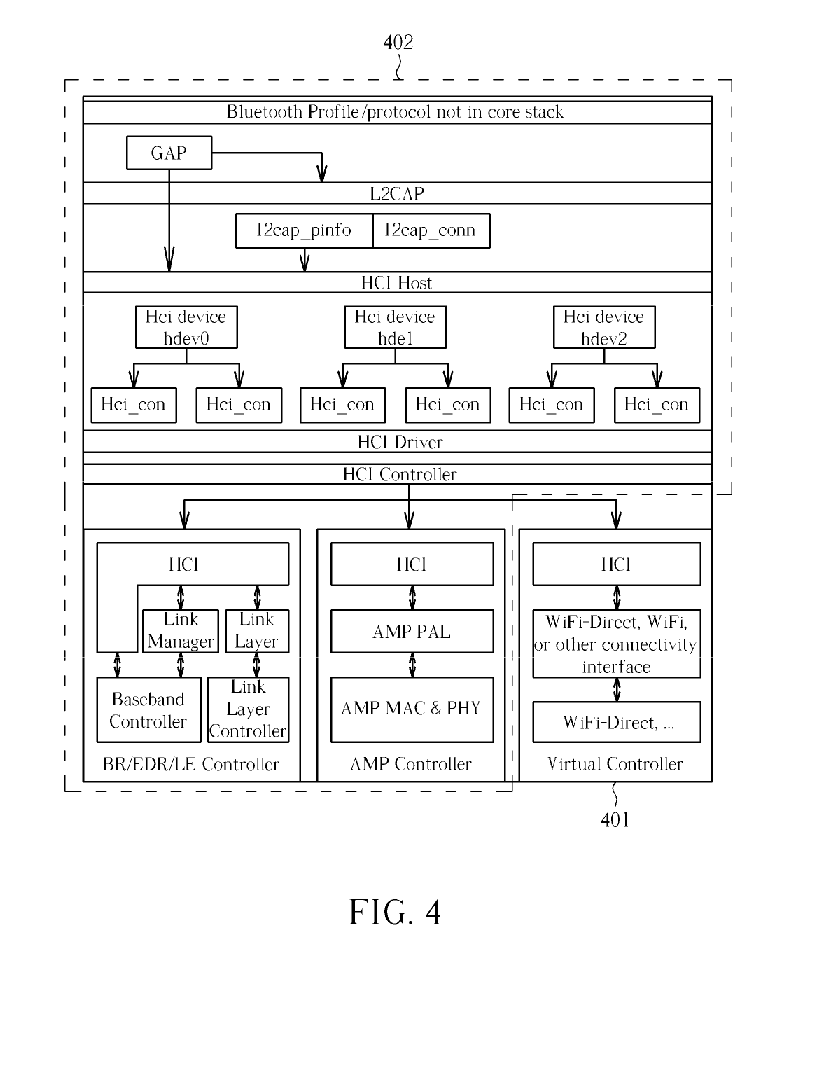

For better understanding of the technical features of the present invention, an exemplary implementation of a modified Bluetooth stack architecture having Wi-Fi/Wi-Fi Direct serving as a transport layer is shown in FIG. 4. As can be seen from the figure, a virtual controller 401 for controlling Wi-Fi/Wi-Fi Direct communication is added to the conventional Bluetooth stack architecture 402. In this way, when the aforementioned second data transaction mode Mode_2 is selected, the Bluetooth data is allowed to be transmitted/received through the Wi-Fi/Wi-Fi Direct link established between the transmitting end and the receiving end. Hence, the use of the Bluetooth application dedicated to the Bluetooth protocol can be extended to the Wi-Fi/Wi-Fi Direct protocol.

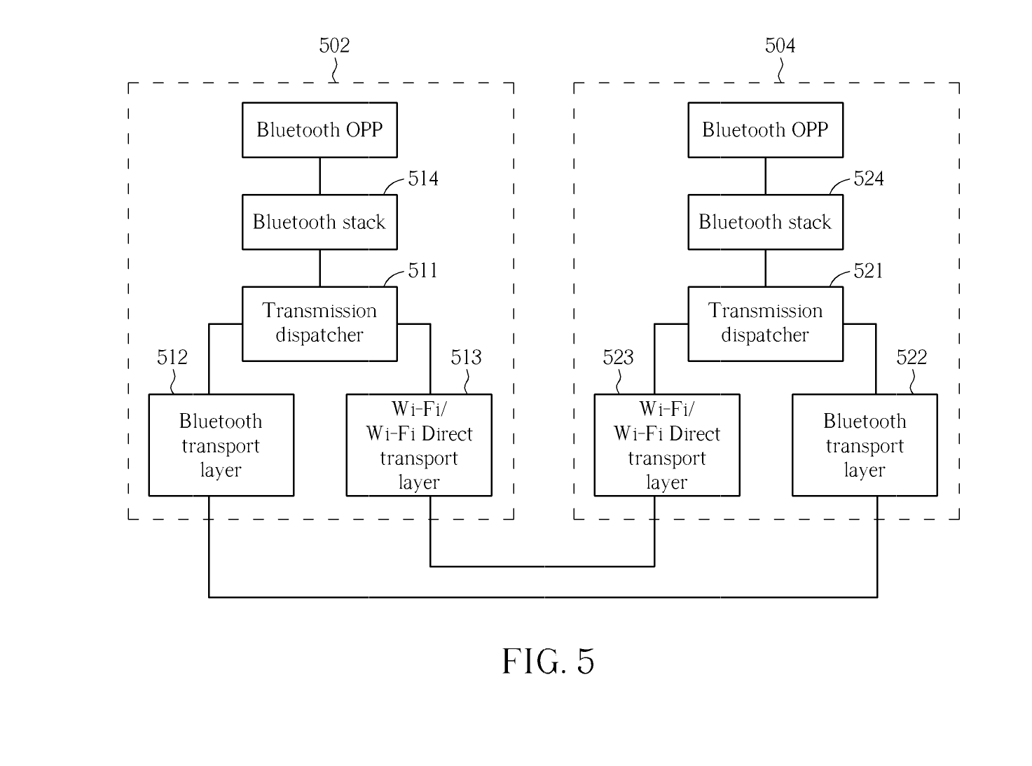

Please refer to FIG. 5, which is a diagram illustrating an exemplary implementation of a Bluetooth application based on the Wi-Fi/Wi-Fi Direct protocol according to the present invention. As shown in FIG. 5, when the aforementioned data transmission method and data reception method are employed, a Bluetooth device 502 can push any object (e.g., wallpaper, ringtone, or video clip) to another Bluetooth device 504 via the Bluetooth object push profile/protocol (OPP) over a Wi-FI/Wi-Fi Direct link. By way of example, but not limitation, the transmission dispatcher 511, the Bluetooth transport layer 512 (e.g., a Bluetooth driver used for driving the communication device 116_1), the Wi-Fi/Wi-Fi Direct transport layer 513 (e.g., a Wi-Fi/Wi-Fi Direct driver used for driving the communication device 116_2), and the Bluetooth stack 514 may be realized using the processor 112 executing the program code PROG1; besides, the transmission dispatcher 521, the Bluetooth transport layer 522 (e.g., a Bluetooth driver used for driving the communication device 126_1), the Wi-Fi/Wi-Fi Direct transport layer 523 (e.g., a Wi-Fi/Wi-Fi Direct driver used for driving the communication device 126_2), and the Bluetooth stack 524 may be realized using the processor 122 executing the program code PROG2. Regarding the Bluetooth device 502, it may employ the aforementioned data transmission method shown in FIG. 2 for transmitting Bluetooth data packets over the Wi-Fi/Wi-Fi Direct link. Regarding the Bluetooth device 504, it may employ the aforementioned data reception method shown in FIG. 3 for receiving Bluetooth data packets transmitted over the Wi-Fi/Wi-Fi Direct link. More specifically, the transmission dispatcher 511 at the transmitting end is configured for receiving Bluetooth data packets generated from an upper layer (i.e., the Bluetooth stack 514) where Bluetooth stack 514 creates the Bluetooth data packets according to data of the object to be pushed to the Bluetooth device 504 by the Bluetooth OPP at the transmitting end, converting the received Bluetooth data packets into Wi-Fi/Wi-Fi Direct data packets, and providing the generated Wi-Fi/Wi-Fi Direct data packets to a lower layer (i.e., the Wi-Fi/Wi-Fi Direct transport layer 513). Next, the Wi-Fi/Wi-Fi Direct transport layer 513 controls the transmission hardware to transmit the received Wi-Fi/Wi-Fi Direct data packets over the Wi-Fi/Wi-Fi Direct link established between Bluetooth devices 502 and 504. When a lower layer (i.e., the Wi-Fi/Wi-Fi Direct transport layer 523) at the receiving end controls reception hardware to receive the Wi-Fi/Wi-Fi Direct data packets transmitted over the Wi-Fi/Wi-Fi Direct link, the received Wi-Fi/Wi-Fi Direct data packets are transmitted to the transmission dispatcher 521 for further processing. The transmission dispatcher 521 is configured for converting the received Wi-Fi/Wi-Fi Direct data packets into Bluetooth data packets, and providing the generated Bluetooth data packets to an upper layer (i.e., the Bluetooth stack 524), where the Bluetooth stack 524 derives data of the object pushed to the Bluetooth device 504 from the Bluetooth data packets, and delivers the derived data to the Bluetooth OPP at the receiving end. As mentioned above, when a second communication protocol supports a longer maximum wireless transmission distance and/or a higher maximum data transfer rate, the service range and/or throughput of an application dedicated to the first communication protocol can be increased with the help of the second communication protocol. Regarding the Bluetooth OPP application shown in FIG. 5, it may benefit from the high-speed data transmission as well as the long wireless transmission distance offered by the employed Wi-Fi/Wi-Fi Direct protocol.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission method, comprising:
receiving a first data of an application dedicated to a first communication protocol;
converting the first data into a second data corresponding to a second communication protocol different from the first communication protocol; and
directing the second data to a communication device which is configured to transmit the second data via the second communication protocol, wherein the first communication protocol does not control the transmission of the second data.

2. The data transmission method of claim 1, wherein the first communication protocol is a wireless communication protocol.

3. The data transmission method of claim 2, wherein the wireless communication protocol is a Bluetooth protocol.

4. The data transmission method of claim 1, wherein the second communication protocol is a wireless communication protocol.

5. The data transmission method of claim 4, wherein the wireless communication protocol is a Wi-Fi protocol or Wi-Fi Direct protocol.

6. The data transmission method of claim 1, wherein the second communication protocol is a wired communication protocol.

7. The data transmission method of claim 6, wherein the wired communication protocol is a universal serial bus (USB) protocol or a serial-port protocol.

8. The data transmission method of claim 1, wherein each of the first communication protocol and the second communication protocol is a wireless communication protocol, and a maximum wireless transmission distance supported by the second communication protocol is longer than a maximum wireless transmission distance supported by the first communication protocol.

9. The data transmission method of claim 1, wherein a maximum data transfer rate supported by the second communication protocol is higher than a maximum data transfer rate supported by the first communication protocol.

10. The data transmission method of claim 1, wherein the step of receiving the first data comprises: receiving first data packets generated from an upper layer complying with the first communication protocol; the step of converting the first data into the second data comprises: converting the first data packets of the first communication protocol into second data packets of the second communication protocol; and the step of directing the second data comprises: providing the second data packets to a lower layer complying with the second communication protocol.

11. A data reception method, comprising:
obtaining a first data from a communication device which is configured to receive the first data via a first communication protocol different from a second communication protocol, wherein the second communication protocol does not control the reception of the first data;
converting the first data into a second data corresponding to the second communication protocol; and
delivering the second data to an application dedicated to the second communication protocol.

12. The data reception method of claim 11, wherein the second communication protocol is a wireless communication protocol.

13. The data reception method of claim 12, wherein the wireless communication protocol is a Bluetooth protocol.

14. The data reception method of claim 11, wherein the first communication protocol is a wireless communication protocol.

15. The data reception method of claim 14, wherein the wireless communication protocol is a Wi-Fi protocol or Wi-Fi Direct protocol.

16. The data reception method of claim 11, wherein the first communication protocol is a wired communication protocol.

17. The data reception method of claim 16, wherein the wired communication protocol is a universal serial bus (USB) protocol or a serial-port protocol.

18. The data reception method of claim 11, wherein each of the first communication protocol and the second communication protocol is a wireless communication protocol, and a maximum wireless transmission distance supported by the first communication protocol is longer than a maximum wireless transmission distance supported by the second communication protocol.

19. The data reception method of claim 11, wherein a maximum data transfer rate supported by the second communication protocol is higher than a maximum data transfer rate supported by the first communication protocol.

20. The data reception method of claim 11, wherein the step of obtaining the first data comprises: receiving first data packets from a lower layer complying with the first communication protocol; the step of converting the first data into the second data comprises: converting the first data packets of the first communication protocol into second data packets of the second communication protocol, and the step of delivering the second data comprises providing the second data packets to an upper layer complying with the second communication protocol.

21. A non-transitory machine readable medium having a program code stored therein, wherein when executed by a processor, the program code causes the processor to execute following steps:
receiving a first data of an application dedicated to a first communication protocol;
converting the first data into a second data corresponding to a second communication protocol different from the first communication protocol; and
directing the second data to a communication device which is configured to transmit the second data via the second communication protocol, wherein the first communication protocol does not control the transmission of the second data.

22. A non-transitory machine readable medium having a program code stored therein, wherein when executed by a processor, the program code causes the processor to execute following steps:
obtaining a first data from a communication device which is configured to receive the first data via a first communication protocol different from a second communication protocol, wherein the second communication protocol does not control reception of the first data;
converting the first data into a second data corresponding to the second communication protocol; and
delivering the second data to an application dedicated to the second communication protocol.
